(19) United States
(12) Patent Application Publication
(10) Pub. No.: US 2006/0206879 A1
(43) Pub. Date: Sep. 14, 2006

(54) Java program method invocation display

(76) Inventor: Harold Batteram, Kortenhoef (NL)

Correspondence Address: Lucent Technologies Inc.;Docket Administrator, Room 3J-219, 101 Crawfords Corner Road, Holmdel, NJ, 07733-3030, US

(21) Appl. No.: 11/077,308

(22) Filed: Mar. 10, 2005

(51) Int. Cl. G06F 9/45

(52) U.S. Cl. 717/140

(57) ABSTRACT

A method is provided of displaying subroutine calls of a computer program upon execution. The computer program is a Java computer program and the subroutine calls are Java Method invocations. The method comprising steps of: invoking a Method and updating a displayed image so as to include a visual representation of the Method invocation.

### FIELD OF THE INVENTION

The present invention relates to a method of displaying subroutine calls of a computer program upon execution. The present invention also relates to a computer, and to computer software.

### DESCRIPTION OF THE RELATED ART

When developing software, it is possible to track subroutine calls, either by modifying source code to include information output steps, or in a Common Object Request Broker Architecture (CORBA) system by using Object Request Broker software.

### SUMMARY OF THE INVENTION

An example of the present invention is a method of displaying subroutine calls of a computer program upon execution. The computer program is a Java computer program and the subroutine calls are Java Method invocations. The method comprising steps of: invoking a Method and updating a displayed image so as to include a visual representation of the Method invocation.

The present invention in its preferred embodiments has the advantage that no changes to the coding of a Java program under test need be made in order to track the Method invocations, and Method returns. However step by step updating of an image is provided to show each Method invocation or return upon that invocation or return occurring. This is a useful tool for test and development of Java programs.

The present invention also relates to a corresponding computer, and to corresponding computer software.

### BRIEF DESCRIPTION OF THE DRAWINGS

An embodiment of the present invention will now be described by way of example and with reference to the drawings, in which:

FIG. 1 is a diagram illustrating a computer architecture according to a first embodiment,

FIG. 2 is a diagram illustrating the Java Invocation Visualiser (JIV), and

FIG. 3 is a diagram illustrating (a) an example of Java source code and (b) the corresponding screen display showing method invocations provided by the JIV to the visual display unit.

FIG. 4 is a diagram illustrating an example of an on-screen window seen when selecting the start point for method invocation visualisation,

FIG. 5 is an example screen display of the method invocations following the FIG. 4 selection, and

FIG. 6 is a diagram illustrating an example of an on-screen window seen in selecting classes of objects between which method invocations are shown.

The drawings are not to scale but are schematic representations.

### DETAILED DESCRIPTION

Java

The Java programming language from SUN Microsystems is widely used to produce software for a variety of areas of applications, including telecommunications. Java is an object-orientated programming language where a program is partitioned into multiple objects. Objects are software entities that can be considered as the building blocks of the program, and typically include a set of attributes (e.g. data values i.e. parameter values) that define the state of the object, a set of methods which modify these attributes, and an identity in order to distinquish one object from another. Methods are referred to in other programming languages as procedures, functions or sub-routines. Upon execution, an object invokes methods, and inputs/outputs parameter values in interaction with one or more other objects. Using Java terminology, objects are grouped by type into object classes, and an individual object is often referred to as an object instance, being an instance of an object class. Java programs are often designed to have multiple execution streams running in parallel. Each execution stream is called a thread.

As shown in FIG. 1, a computer 2 is provided on which a Java program 4 as written by a programmer is compiled into Java byte code instructions 6 by a Java compiler 8. The Java program refers to objects 10, methods 12 and threads 14, as explained above. The computer includes a visual display unit 16, such as a cathode ray tube, and a keyboard 18.

Java byte code 6 is an intermediate software product. It cannot be directly executed on a target computer (such as computer 2 or another (not shown)) but needs to be interpreted by a so-called Java Virtual Machine, JVM 20.

Java Virtual Machine

The Java Virtual Machine (JVM) 20 is responsible for executing each byte code instruction in sequence on the target computer by translating byte code instructions, which are computer platform independent, into native computer, i.e. computer platform specific, instructions. Byte code instructions are computer platform independent; the Java Virtual Machine (JVM) however is computer-platform dependent. A computer platform is a combination of computer hardware and the operating system running on that hardware e.g. an IBM compatible personal computer running Microsoft Windows XP, a SUN sparc running Solaris, or an IBM compatible personal computer running Linux. For each such type of computer platform a corresponding Java Virtual Machine (JVM) exists.

Irrespective of the particular computer platform, the Java Virtual Machine (JVM) 20 includes a standard Java Platform Debugger Architecture (JPDA) 22 that allows a separate program to interact with the Java Virtual Machine (JVM) 20. The Java Platform Debugger Architecture (JPDA) 22 offers standard interfaces that a separate program can use to communicate with the JVM 20, one such interface being the Java Debug Interface (JDI) 24.

Java Invocation Visualiser

Such a separate program, known as a Java Invocation Visualiser, has been developed. The JIV is denoted by reference numeral 26 in FIG. 1. The JIV 26 provides visualisation of Java program interactions in, effectively or apparently, real time. The Java Invocation Visualiser (JIV) 26 captures the execution of the Java program 4 on the Java Virtual Machine (JVM) 20 using the Java Platform Debugger Architecture (JPDA) 22, in particular its Java Debug Interface (JDI) 24, by non-intrusive interception of the program execution flow at the level of Java byte code instructions 6.

The JIV 26 uses the Java Debug Interface (JDI) 24 to instruct the Java Virtual Machine 20 such that the Java Invocation Visualiser (JIV) 26 is notified each time that the Java Virtual Machine (JVM) 20 enters a method or exits a method in the course of interpreting the Java byte code 6 corresponding to the Java source code program 2.

The JIV 26 orders that received information from concurrently executing threads, and formulates data for display as an image 28 on the visual display unit 6. The data represents the method invocations, and method returns, between the objects referred to by the Java program as it is executed.

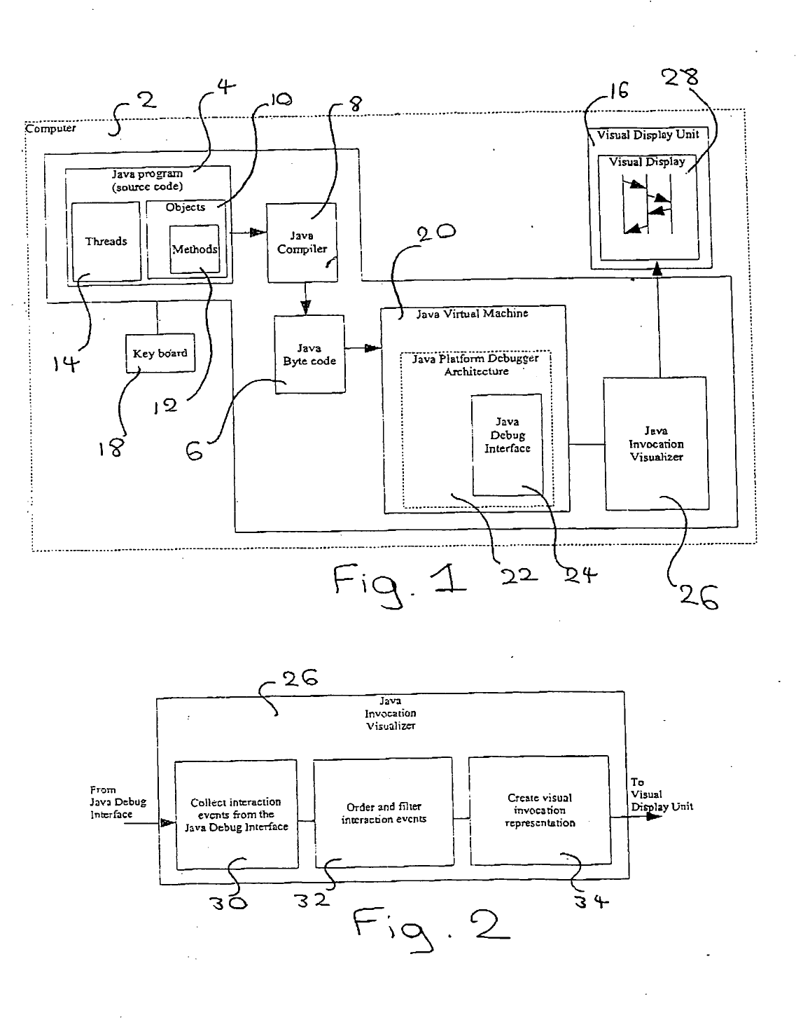

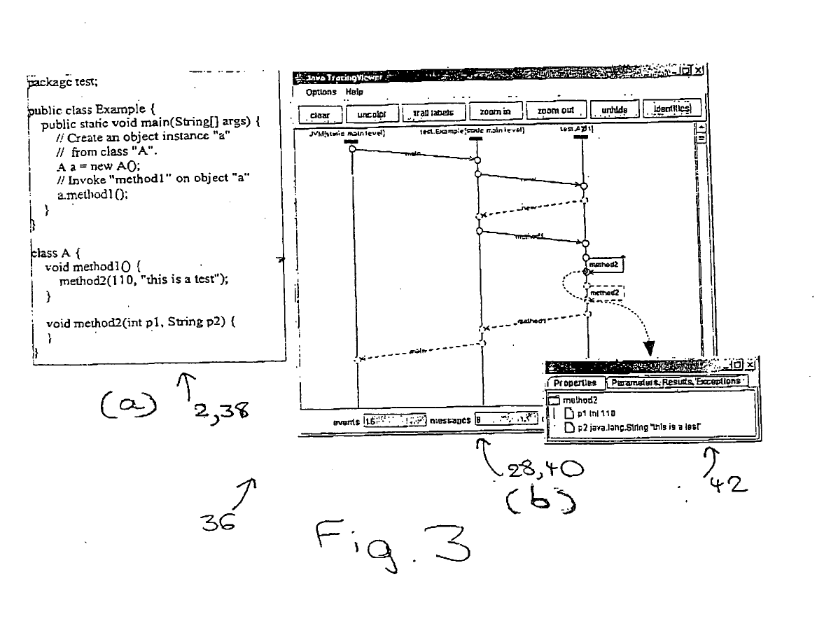

As shown in FIG. 2, the JIV 26 is made up of a data collection stage 30, an ordering/filtering stage 32 and a visual representation generator 34. Data about method invocations and returns is received by the data collection stage 30 from the Java Debug Interface (JDI) 24. These are ordered by the ordering/filtering stage 32 into the order that they occurred in each thread of the program, and the invocations and returns of each method, or those of the methods selected as being of interest, are converted by the visual representation generator 34 into appropriate video data for display. The video data is transmitted to the visual display unit 16 for display as an image 28.

The data for display is real time in the sense that it is updated upon each occurrence of a method invocation or return, or at least each invocation or return of a method in a set selected by the programmer. Accordingly the displayed image 28 is updated from time to time upon a method invocation or return occurring.

This image 28 allows programmers to see that runtime behaviour of their programs, and to appreciate the causality relations between methods, objects etc in the execution flow. The image 28 helps the programmer in locating errors, to analyse method parameter values or analyse earlier programs written by others.

Java Program and Corresponding Method Invocation Image

By way of example of a Java source code program 2 and a corresponding image 28 that would be seen on the visual display unit 16, the reader is now referred to FIG. 3. The on-screen display 36 includes a first window 38 showing a listing of the Java source code program 2 and a second window 40 shows the image 28 representing the method invocations and returns.

In the method invocation image such as shown in window 40 of FIG. 3, the vertical lines represent objects, i.e. instances of object classes, with the object class name and unique object instance identification label shown at the top of each vertical line. The circles indicate interaction points between communicating Java objects. Specifically, solid lines between interaction points indicate a method being invoked, with the arrow indicating the direction of the invocation. Dashed lines with arrows indicate the return path of the invocation.

As can be seen in FIG. 3, in the example Java program shown in the first window 38 an object, named “a”, of a class of objects, denoted “A”, is used. In other words, an “object instance” is created. A method, named Method1, is invoked. Method 1 in turn invokes another method, named Method2, which operates on the object “a”.

The corresponding image 28 shown in the second window 40 is the output from the JIV 26 when the example program shown in window 38 is run. The image 28 shows the program flow starting with invocation of a preliminary method, which is denoted “Main”, by the Java Virtual Machine (JVM) 20. This is followed by the invocation of a method denoted “new” in order to create the object instance referred to above, i.e. to start to use the object “a”. The return of method “new” is shown. The invocations of Method1 then Method2 are then shown. After this, the returns for Method2 then Method1 then method “main” are shown.

The image develops step-by step. Upon each invocation or return being completed, the image 28 is updated accordingly so as to represent that invocation or return.

Extra Information

As shown in FIG. 3, additional information can be displayed at each interaction point. The programmer selects an interaction point, for example by clicking-on it using a computer mouse, causing a pop-up window 42 such as shown in FIG. 3 to be displayed. The window 42 displays information 44, such as a time stamp indicating the time of the method invocation, and parameter values as these might be useful diagnostics.

Selecting Methods of Interest to the Programmer

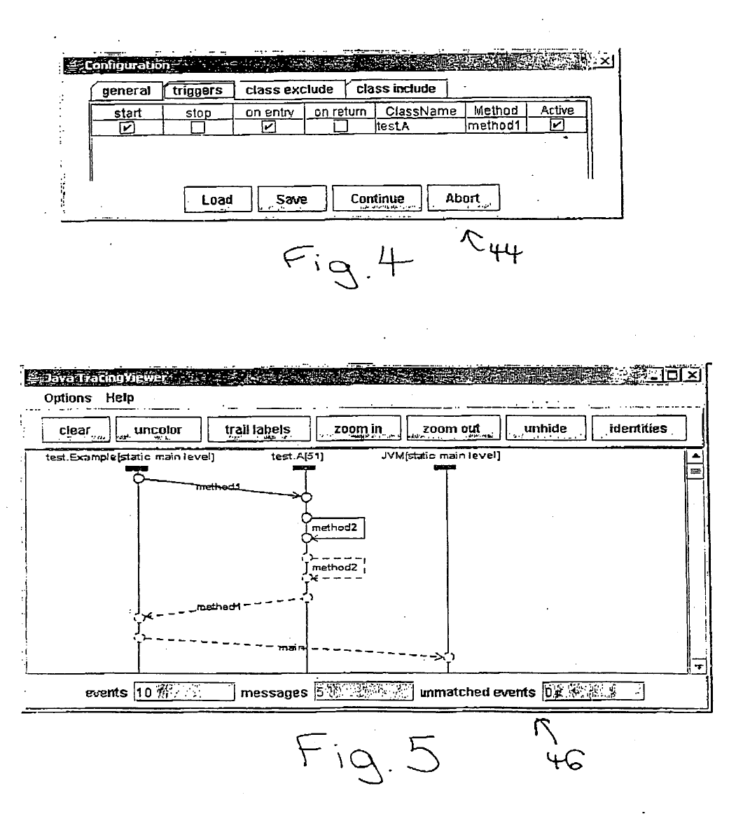

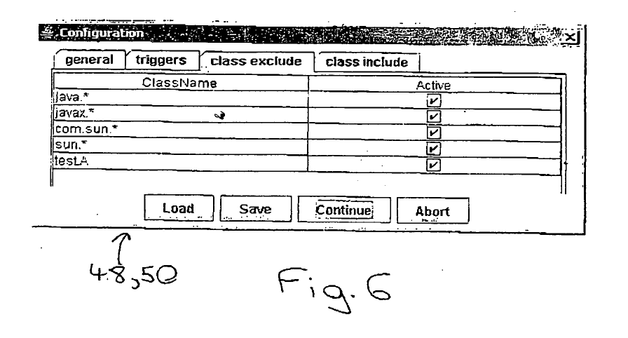

The Java Invocation Visualiser 26 includes various selection (in other words, filtering) mechanisms to enable the programmer or other user to select the portion or portions of the program for which method invocations are to be displayed. The programmer can select trigger events to start or stop the display of method invocations. This is done by clicking on appropriate tick-boxes/check-boxes in an on-screen window, an example of which is shown in FIG. 4. The example shown in FIG. 4 shows an on-screen window 440 for setting the display to start showing method invocations from the point when a method Method1 of an object instance belonging to a class of objects test.A is invoked. The resulting example image 46 is shown in FIG. 5 corresponding to the example Java program shown in FIG. 3.

Invocations to objects of a specified class or classes can be included or excluded for display. For example, method invocations to and from object instances of excluded object classes are not shown on a method invocation display image. An example is shown in FIG. 6.

FIG. 6 shows an example image 48 including a table 50 that lists all the classes of objects that are to be excluded from the invocations shown. A wildcard character “*”, which is shown in FIG. 6, is used as a shorthand notation to indicate all classes of objects within a particular Java package; a package being a suite of objects.

General

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of displaying subroutine calls of a computer program upon execution,
the computer program being a Java computer program and the subroutine calls being Java Method invocations, the method comprising steps of:
invoking a Method,
updating a displayed image so as to include a visual representation of the Method invocation.

2. The method according to claim 1, where information of the Method invocation is obtained from a Java Debug Interface of a Java Virtual Machine.

3. The method according to claim 1, wherein each of a series of Method invocations is additionally represented in turn in the displayed image.

4. The method according to claim 1, in which the image is updated to display a representation of a Method return or each of a series of Method returns.

5. The method according to claim 1, in which only Method invocations or Method returns occurring after a selected trigger event in the program are represented.

6. The method according to claim 1, in which only invocations to, or returns from, Methods from a selected class or classes of Methods are represented.

7. The method according to claim 1 in which Java objects are represented substantially as spaced apart parallel lines and Method invocations and/or returns are represented substantially as arrows between the lines.

8. The method according to claim 1, in which Method parameter values and/or times of Method invocations are selectably displayed.

9. A computer comprising a Java Virtual Machine including a Java Debug Interface;
the Java Debug Interface being connected to a Method invocation visualisation stage;
the visualisation stage comprising a data collection stage which receives information of Method invocations in a Java program upon execution, a stage for sequencing and/or selection, and a visual representation generator;
the visual representation stage being connected to a visual display unit on which an image is updated over time to include a visual representation of each of a series of method invocations.

10. Computer software which, when run on a computer comprising a Java Virtual Machine including a Java Debug Interface,
over time records each of a series of Method invocations by a Java program upon execution of said program, and
at times provides corresponding data for display representing the Method invocations made by then.
